(19) United States
(12) Patent Application Publication
(10) Pub. No.: US 2007/0122114 A1
(43) Pub. Date: May 31, 2007

(54) Recording apparatus for initializing recording media

(75) Inventors: Keisuke Kawamoto, Yokohama (JP); Masahiro Fujimoto, Yokohama (JP); Kazunori Uemura, Ebina (JP); Kenji Ichige, Yokohama (JP); Keiji Nagayama, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/543,184

(22) Filed: Oct. 3, 2006

(30) Foreign Application Priority Data
Nov. 30, 2005 (JP) 2005-344878

(51) Int. Cl. H04N 7/00

(52) U.S. Cl. 386/95

(57) ABSTRACT

In a recording apparatus equipped with a drive apparatus for recording data on a recording medium such as an optical disk, and a function capable of initializing a management information area of the recording medium, a storage unit is further provided. The storage unit stores thereinto initializing data which is used to be recorded on the management information area of the recording medium when the recording medium is initialized. In the case that an initializing operation is instructed, the recording apparatus records the initializing data which has been stored in the storage unit on the management information area of the recording medium from a beginning area thereof. Thus, a user no longer waits to use the recording medium until the initializing operation is accomplished when such a recording medium as a new optical disk is used, resulting in an improvement of user operability.

The present patent application claims priority for Japanese patent application P2005-344878 filed on Nov. 30, 2005, the content of which is hereby incorporated by reference into this application.

### BACKGROUND OF THE INVENTION

The present invention generally relates a recording apparatus. More specifically, the present invention is directed to such a technical idea capable of initializing a file management information recording areas of recording media in a high speed.

Very recently, specific attentions have been paid to recording/reproducing apparatus which have employed DVD disks (Digital Versatile Disks), namely optical disks functioning as recording media, since these recording/reproducing apparatus are capable of storing large amounts of image data on these DVD disks.

As to recording type DVD disks capable of recording image data, the following disks are usable: DVD-R (Digital Versatile Disk Recordable) as write-once type DVD disks; DVD-RW (Digital Versatile Disk Rewritable), DVD+RW (plus RW), and DVD-RAM (Digital Versatile Disk Random Access Memory) as rewritable recording media. These recording/reproducing apparatus are required to record/reproduce data with respect to these DVD disks.

In a recording type optical disk, a structure of a recording portion thereof may be roughly subdivided into two recording areas. That is, one divided recording area corresponds to a physical area where recording/reproducing operations can be carried out by a drive apparatus. Another divided recording area corresponds to a logic area (logic data area) where image data desired by a user can be recorded and reproduced. Furthermore, both a management information area of an optical disk and a user data area have been arrayed in the logic area. When a recording type optical disk is used, before this optical disk is used, namely the desirable image data is recorded, both a physical area and a management information area must be initialized in correspondence with a file format to be employed and a format standard to be employed. An initialization executed in a physical area implies such a data recording operation that data determined in such standards as status information of an optical disk, a recording end position, and a final address of the optical disk are recorded on this physical area. An initialization executed in a management information area implies such a data processing operation that data determined based upon a file system standard used in an optical disk are recorded on this management information area, which is typically known as the UDF(Universal Disk Format) standard.

In connection with these recording type optical disks, a DVD-RW disk will now be explained which constitutes one of recording type DVD disks. A feature of this DVD-RW disk is that two sorts of initializing formats are acceptable. That is, one acceptable initializing format is an initializing format which corresponds to a standard capable of realizing reproduction compatibility with a reproduction-dedicated DVD disk in a write-once type (video format) optical disk. The other acceptable initializing format is an initializing format which corresponds to a standard capable of editing data after the data has been recorded (for example, partial deletion of data is available), although having no reproduction compatibility with respect to a reproduction-dedicated DVD disk in a rewritable type (video recording format) optical disk.

When a new DVD-RW disk is used, or when all of data recorded on a DVD-RW disk under use are deleted and then, new image data is recorded from a beginning recording area thereof, a desirable initializing format must be selected from the write-once type (video format) and the rewritable type video recording format). Since DVD-RW disks own such characteristics adaptable to two sorts of initializing formats, management information areas thereof are not yet initialized at a time when DVD-RW disks are shipped from optical disk manufacturers. Accordingly, when these DVD-RW disks are newly used, initializing operations of management information areas thereof are necessarily carried out.

Two sorts of the above-described initializing formats which are used in a DVD-RW disk confirm to the UDF standard. While a management information area has been arrayed on an inner circumferential portion of the DVD disk, data required in an initializing operation (will be referred to as “initializing data” hereinafter) is determined based upon this UDF standard. Before such a DVD-RW disk is used, the management information area must be initialized. As to the initializing data which is recorded on the management information area, an effective information amount as management information is small with respect to an amount of such information which can be recorded on this management information area, and the initializing data must be recorded at a predetermined place within the management information area, while effective management information has been arrayed in an intermittent manner. Also, data “0” having an exclusive meaning has been recorded on such a portion that the effective management information is not recorded. As a consequence, major portions of the management information area correspond to such portions having no effective management information, and therefore, which are embedded by the data “0” having the exclusive meaning.

As previously explained, since there are many portions where the effective management information is not recorded, the conventional initializing operation of the management information area is carried out by performing the below-mentioned operations:

Operation (1): data “0” is recorded over an entire management information area.

Operation (2): an optical head is returned to a head area of the management information area.

Operation (3): the optical head is moved (sought) to a predetermined place within the management information area.

Operation (4): effective management information is recorded.

Operation (5): the above-described operations (3) and (4) are repeated so as to record all of management information.

In the above-explained conventional initializing operation for the management information area, a plenty time has been consumed in the seeking operation by the operation (3). Also, after the data “0” has been recorded in the operation (1), the management information is overwritten on the data “0” in the operation (4). As a result, a time loss occurs since the recording operations are overlapped with each other. Because of these factors, the initialization time of the management information area takes a very long time. In video cameras, the above-explained time loss may lose photographing chances. As a consequence, various technical ideas capable of initializing these management information areas in an effective manner have been proposed.

As such conventional technical ideas, for example, JP-A-2000-090579 has been proposed. That is, while as a purpose, “a large amount of phase changing type optical disks are formatted” is desired, the below-mentioned solving idea has been proposed as the solving means, namely, “while the application specific data which contains at least the UDF data and the file structure for format purpose are stored in the storage apparatus 53, the application specific data stored in the storage apparatus 53 is written on the optical disk after the physical format has been made. As a result, since the optical disks are formatted based upon the format data stored in the storage apparatus 53, the formatted phase changing type optical disks can be produced in mass production.”

As another conventional technical idea, for example, JP-A-2003-162868 has been proposed. That is, while as a purpose, “a lengthy waiting time for recording/reproducing data need not be required in order to perform the formatting process operation with respect to the rerecordable optical disk by overwriting the data” is required, as the solving means, the below-mentioned technical idea has been proposed: Namely, “after the formatting process operation is commenced with respect to the optical disk, the next process operation is acceptable in the step Si; such a formatting process operation capable of recording the fixed length packet on either the entire area or the predetermined area of the recording area of the optical disk is carried out in the background mode in the step S2; the judgement is made as to whether or not the entire area to be formatting-processed is embedded by the fixed length packets in the step S3; if the entire area is not embedded by the fixed length packets, then the process operation of the step S2 is continued, whereas if the entire area is embedded by the fixed length packets, then the process operation is ended.”

### SUMMARY OF THE INVENTION

As previously explained, when a DVD disk is used, an initializing operation is required based upon in a selected initializing format. A user must perform the various processing steps until a DVD-RW disk is brought into a recordable condition. That is, in these processing steps, the user inserts an optical disk, the inserted optical disk is recognized, the initializing format is selected, and thereafter, an initializing process operation is carried out. In particular, this initializing operation requires lengthy time. In video cameras, this time loss may eliminate the photographic chances.

JP-A-2000-090579 has proposed such a conventional technique that since the data stored in the storage apparatus (ROM), which is required in the initializing operation, is written in the optical disks, a large amount of initialized optical disks can be manufactured in mass production. However, this conventional technical idea does not consider the time reduction when the initializing data is recorded. Therefore, the time loss caused by seeking the optical head cannot be solved, so that lengthy initializing time is required. Accordingly, there is a problem that the waiting time until the recording operation is commenced becomes long.

For example, when the flow chart of FIG. 3 of JP-A-2000-090579 is considered, after the formatting operation has been carried out in the step S1, the error check is carried out from the step S2 to the step S4. Thereafter, the UDF data and the like are recorded (step S5). As a consequence, at least the formatting operation and the writing operation of the UDF data are carried out in two divided seeking operations, so that a lengthy time is necessarily required for two divided seeking operations. Furthermore, if the flow chart of FIG. 3 is carried out after another physical formatting operation, then the seeking operations are required at least 3 times, which takes more lengthy time.

Also, in the conventional technical idea described in JP-A-2003-162868, the following idea has been proposed. That is, since the optical disk is brought into the recording operation, startable condition before the initializing operation is accomplished, it may be regarded that the initializing time may be shortened. However, this conventional idea is not directly related to the technical idea capable of shortening the processing time required for the initializing operation. Since the optical disk is brought into the recordable condition before the initializing operation, in such a case that the user tries to eject the optical disk after the recording operation is stopped, the user must wait for this disk ejection until the initializing operation is ended. Therefore, there is such a problem that the user operability is deteriorated. Furthermore, after the recording operation by the user is ended, the initializing operation is restarted. However, in such a case that such a trouble happens to occur (for example, power supply is instantaneously interrupted) before the initializing operation is accomplished, there are other problems that the recorded data may be destroyed, and thus, the optical disk is brought into unusable condition.

As a consequence, for instance, in a recording apparatus using a recording medium such as an optical disk, initializing time with respect to the recording medium can be shortened, and superior user operability can be realized while waiting time is reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a conceptional diagram for explaining recording areas of a recording type optical disk.

FIG. 2 is a basic structural block diagram for representing a video camera according to an embodiment of the present invention.

FIG. 3 is a flow chart for describing initializing sequential operations of the video camera according to the embodiment.

FIG. 4 is a diagram for schematically showing initializing data structures of the video camera according to the embodiment.

### DESCRIPTION OF THE INVENTION

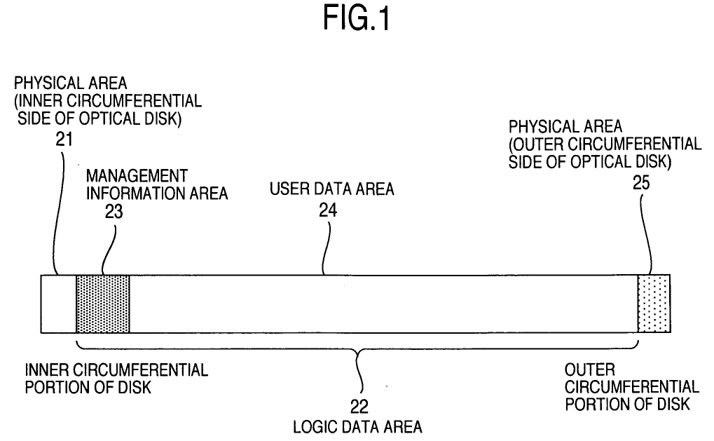

Referring now to FIG. 1 to FIG. 4, a video camera using a DVD disk according to an embodiment of the present invention will be described.

A first description is made of structures as to recording areas of an optical disk with reference to FIG. 1. In FIG. 1, there is shown a conceptional diagram as to recording areas of a recording type optical disk.

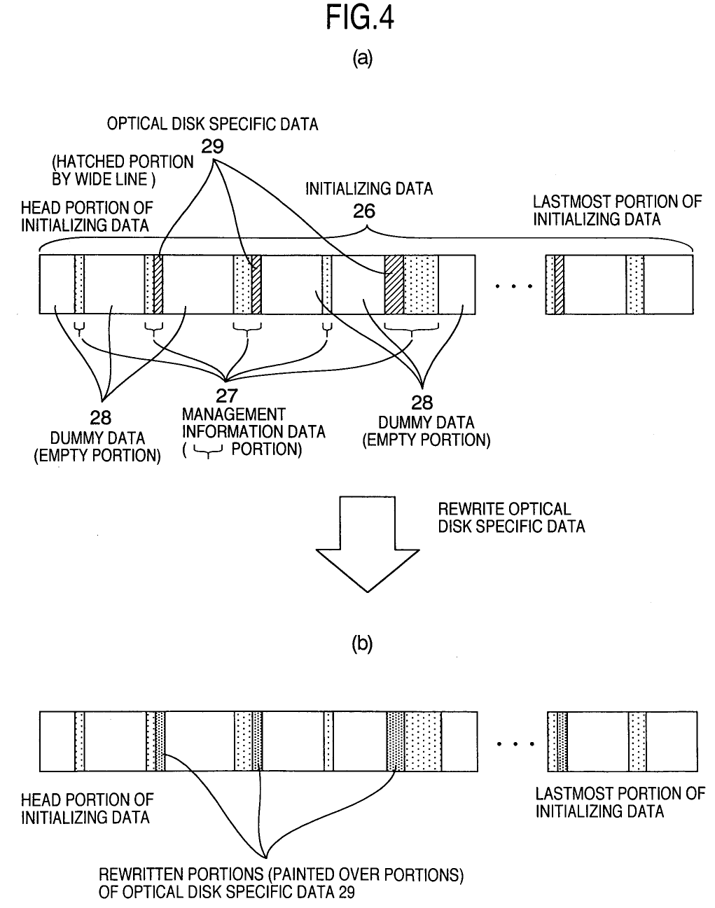

In this drawing, reference numeral 21 shows a physical area (inner circumferential side of disk); reference numeral 22 indicates a logic data area; reference numeral 23 represents a management information area; reference numeral 24 shows a user data area; and also, reference numeral 25 indicates a physical area (outer circumferential side of disk). A term “initializing operation” implies such a process operation executed with respect to the management information area 23. As indicated in the drawing, the physical area (inner circumferential side of disk) 21, the logic data area 22, the management information area 23, the user data area 24, and the physical area (outer circumferential side of disk) 25 are arrayed in this order from the inner circumferential portion of the disk to the outer circumferential portion thereof. In this disk, a term “initializing data” implies such an array data which is recorded over an entire area of the management information area 23 during an initializing operation, and a structure of this initialization disk will be explained later with reference to FIG. 4.

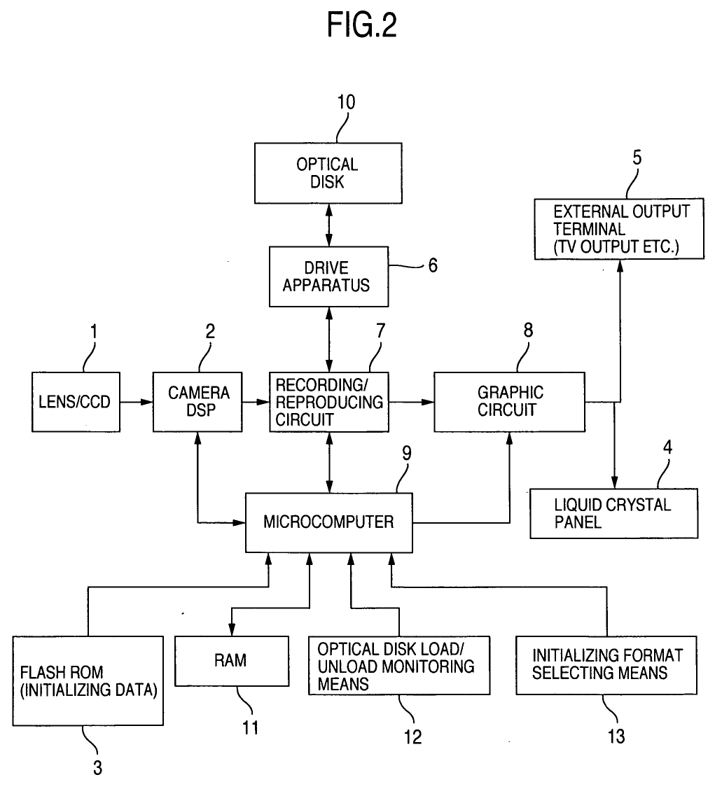

Next, an arrangement of the video camera according to the embodiment and a brief operation thereof will be described with reference to FIG. 2. FIG. 2 is a block diagram for indicating a basic structure of the video camera according to the embodiment.

In this drawing, reference numeral 1 shows a lens/CCD (Charged-Coupled Device); reference numeral 2 indicates a camera DSP (Digital Signal Processor); reference numeral 3 represents a flash ROM; reference numeral 4 denotes a liquid crystal panel; reference numeral 5 shows an external output terminal; and reference numeral 6 indicates a drive apparatus. Also, reference numeral 7 shows a recording/reproducing circuit; reference numeral 8 indicates a graphic circuit; reference numeral 9 denotes a microcomputer; reference numeral 10 shows an optical disk; reference numeral 11 indicates a RAM (Random Access Memory); reference numeral 12 denotes an optical disk load/unload monitoring means; and further, reference numeral 13 indicates an initializing format selecting means.

When a recording operation is carried out in the video camera, an imaging signal acquired from the lens/CCD 1 is inputted via the camera DSP 2 to the recording/reproducing circuit 7. After the recording/reproducing circuit 7 performs various sorts of signal process operations, for instance, a coding operation, with respect to the inputted imaging signal, image data is recorded on the optical disk 10 by the drive apparatus 6. Also, at the same time, a size-reduced image (thumbnail image) used to display a recording picture menu, and the like are produced by the microcomputer 9. This thumbnail image and scene management information such as a recording time, a data, and a recording mode are recorded on the optical disk 10. On the other hand, such an image signal which has been entered to the recording/reproducing circuit 7 before being coded is processed in the graphic circuit 8 so as to superimposed character information and the like on this image signal. Then, the image signal processed by this graphic circuit is transferred to the liquid crystal panel 4, and/or transferred to an external display apparatus, and the like, which are connected via the external output terminal 5 to the video camera.

When a reproducing operation is carried out in the video camera, image data is read out from the optical disk 10 via the drive apparatus 6, and then, the read image data is entered to the recording/reproducing circuit 7. Such an image signal which has been processed by the recording/reproducing circuit 7 by way of, for example, a decoding process operation, is inputted to the graphic circuit 8. Thereafter, the image signal processed by the graphic circuit 8 is transferred to the liquid crystal panel 4, or the external output terminal 5 so as to be displayed thereon. It should be understood that all of these operations are controlled by the microcomputer 9.

The flash ROM 3 has previously stored thereinto a program of the microcomputer 9, data required for control operations, and data array (initializing data). The data array (initializing data) conforms to the UDF (Universal Disk Format) standard, and should be recorded over an entire area of the management information area 23 of the optical disk 10. For example, initializing data corresponds to such an array data that data of “0” and management information data are arrayed in a predetermined interval in a serial manner, and owns such a data amount substantially equal to a data amount of the management information area 23. The microcomputer 9 reads out data stored in the flash ROM 3, if necessary. Also, since initializing data own different structures depending upon initializing formats, a plurality of initializing data have been stored in the flash ROM 3, while these plural initializing data correspond to initializing formats of optical disks which are adapted to video cameras. Since the initializing data own large amounts of data, these initializing data have been stored in the flash ROM 3 under compressed data condition in order to reduce this data amount occupied in the flash ROM 3. Alternatively, these initializing data may not be compressed. It should also be understood that although the flash ROM 3 is employed in this embodiment, since other storage media such as a ROM and an EEPROM may realize similar functions, the recording medium is not limited only to such a flash ROM 3.

The RAM 11 temporarily stores thereinto image data and data required for controlling the video camera. The optical disk load/unload monitoring means 12 corresponds to such a means for sensing load/unload conditions of the optical disk 10. As a concrete example, a switch for detecting as to whether or not the optical disk 10 is present is provided in an inserting unit, or the like so as to monitor load/unload conditions of the optical disk 10. The initializing format selecting means 13 corresponds to a means for inputting/instructing an initializing operation of the optical disk 10, and for selecting an initializing format corresponding to the optical disk 10. Concretely speaking, while selectable initializing formats are displayed on the liquid crystal panel 4, a proper initializing format is selected by operating an input apparatus (not shown) such as a cross-shaped cursor button.

As the optical disk 10 capable of handling picture signals, for example, the following optical disks are available: a DVD-ROM disk functioning as a reproduction dedicated optical disk; a DVD-R disk functioning as a write-once type disk; DVD-RW, DVD+RW, and DVD-RAM disks etc. functioning as a rewritable optical disk.

The initializing operation related to the embodiment will now be summarized. That is, when the optical disk 10 is inserted into the video camera, if the optical disk load/unload monitoring means 12 senses the insertion of the optical disk 10, then the drive apparatus 6 performs a recognizing process operation including a checking operation for checking as to whether or not an initializing operation is requested to be carried out with respect to the loaded optical disk 10. In the case that the initializing operation is required, the initialization selecting means 13 performs such an operation that an initializing format is selected from a selection screen displayed on the liquid crystal panel 4, and then, the selected initializing format is executed. When the initializing operation is commenced, such an initializing data corresponding to the selected initializing format is read out from the initializing data stored in the flash ROM 3, and then, the read initializing data is expanded in the ROM 11. The expanded initializing data is recorded via the drive apparatus 6 on the management information area 23 of the optical disk 10 from the beginning area thereof. It should also be noted that after data specific to an optical disk produced in the microcomputer 9 is replaced by such a data specific to the optical disk present in initializing data, the replaced data may be alternatively recorded on this management information area 23 if required.

As previously explained, the initializing operation as to the optical disk 10 can be carried out by merely performing the writing operation only one time in such a way that the initializing data in which the dummy data and the management information data have been previously arrayed in the serial mode are sequentially and continuously recorded from the beginning area of the management information area 23 up to the last area thereof. As a consequence, such an operation that an optical head is moved (sought) to a position of management information is no longer required, so that the initializing time can be shortened, and the waiting time by the user can be shortened, resulting in an improvement of user operability.

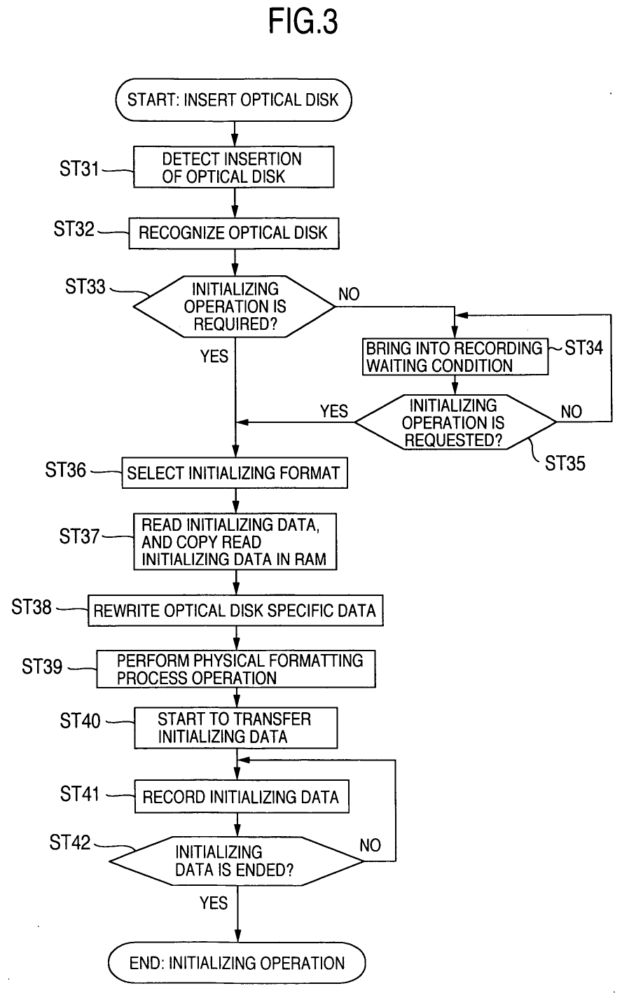

Next, a description is made of initializing process operations after the optical disk 10 is inserted into the video camera until the video camera is brought into a recordable condition with reference to FIG. 3. That is, FIG. 3 is a flow chart for describing initializing sequential operations of the video camera according to this embodiment. It should also be understood that the initializing process operation is explained in such a case that a DVD-RW disk is inserted as the optical disk 10 in the video camera.

When the optical disk 10 is inserted in the video camera, the optical disk load/unload monitoring means 12 detects that the optical disk 10 is inserted in a step (being indicated as “ST” in drawing) 31. In a step 32, the micro computer 9 informs such a fact that the optical disk 10 is inserted with respect to the drive apparatus 6, and the drive apparatus 6 commences a disk recognizing operation of the optical disk 10. The drive apparatus 6 informs a disk judgment result of the optical disk 10, and such an information to the microcomputer 9, while the above-explained information contains an initializing time of an optical disk, and a status as to whether or not the initialization of the optical disk 10 is present. In a step 33, the drive apparatus 9 judges a necessity of the initializing operation. In the case that the inserted optical disk 10 is such an optical disk which has not yet been initialized and is required to be initialized, this initializing process operation is advanced to a step 36. In the case that the inserted optical disk 10 has already been initialized and also a data recordable area of the optical disk 10 owns a margin, the initializing process operation is advanced to a step 34. In this step 34, such a fact that the optical disk 10 is under recordable condition is displayed on the liquid crystal panel 4, and the initializing process operation is brought into such a record waiting status that the microcomputer 9 waits either a recording start instruction or an initializing instruction, which are issued from the area.

After the record waiting status of the step 34, in the case that the initializing operation is instructed by the initializing format selecting means 13 in a step 35, the initializing process operation is advanced to a step 36. To the contrary, in the case that the initializing operation is not instructed by the initializing format selecting means 13 in the step 35, the initializing process operation is returned to the previous step 34 in which the process operation is brought into the record waiting status.

In the step 36, such a screen for selecting two sorts of initializing formats is displayed on the liquid crystal panel 4 so as to select a desirable initializing format, while these two initializing formats are a write-once type (video format) and a rewritable type (video recording format). When the initializing format is selected by the initializing format selecting means 13, the microcomputer 9 reads out such an initializing data which corresponds to the selected initializing format from the flash ROM 3, and then copies the read initializing data in the RAM 11 in a step 37. In this step, in such a case that the initializing data has been compressed/stored in the flash ROM 3, the microcomputer 9 expands the compressed initializing data when being copied in the RAM 11.

In a step 38, the microcomputer 9 rewrites data specific to an optical disk by such a data on the initializing data copied in the RAM 11 at a predetermined position defined in the UDF standard (namely, data updating operation). This optical disk specific data corresponds to an initialization daytime, and initialization time, CRC (Cyclic Redundancy Check) data, and the like. In a step 39, the microcomputer 9 issues an initializing instruction to the drive apparatus 6, and then, the drive apparatus 6 initializes the physical area (inner circumferential side) 21 of the optical disk 10, if required. In a step 40, the microcomputer 9 instructs a writing operation of the initializing data with respect to the drive apparatus 6, and sequentially transfers the updated initializing data on the RAM 11 to the drive apparatus 6. In a step 41, the drive apparatus 6 starts to record the initializing data updated by the RAM 11 from the head area of the management information area 23 in a continuous manner. In a step 42, the drive apparatus 6 performs the recording operation of the initializing data until the data transferred from the RAM 11 becomes empty. Since the initializing data owns such a large data amount capable of being recorded on the entire area of the management information area 23, the drive apparatus 6 continuously records the initializing data up to such an area which is the last area of the management information area 23 just before a head area of the user data area 24.

It should be understood that the initializing process operations defined from the step 39 up to the step 41 are continuous operations and data structures which are written within one seeking operation, as can been understood from FIG. 1, FIG. 3, and FIG. 4. In this case, a term of “one seeking operation” implies that if a circular optical disk is loaded, then an optical head seeks this circular optical disk from an inner circumferential side (otherwise, outer circumferential side) thereof to an outer circumferential side (otherwise, inner circumferential side) thereof along only one direction, namely one going path, but does not involve a return path. The circular optical disk may be stopped, and a rotation speed thereof may be changed.

In the above explanation of FIG. 3, in the step 38, the data specific to the optical disk has been rewritten by the initializing data copied in the RAM 11. Alternatively, while the process operation of the step 38 is deleted, the copied initialization information may be directly recorded on the optical disk 10.

Also, in such a case that a data amount of initializing data is large and cannot be entirely copied in the RAM 11, first of all, only a predetermined amount of initializing data is copied in the RAM 11 which can be copied therein, and thereafter, such an initializing data which could not be copied in the RAM 11 may be sequentially copied in the RAM after the initializing data which has been transferred to the drive apparatus in the background while the drive apparatus 6 is recording the initializing data on the optical disk 10 is deleted so as to secure an empty storage space in this RAM 11.

Alternatively, such an operation for performing an error checking operation as to the written physical format and/or the written initializing data may be carried out after the step 42. As explained above, one error checking operation is executed after the physical formatting operation and the writing operation of the initializing data have been accomplished within a series of seeking operation. As a result, even if such an error checking operation is involved in the seeking operation, the resulting initializing operation may be carried out at a higher speed.

Next, a structure of previously stored initializing data will be explained with reference to FIG. 4. FIG. 4 are schematic diagrams as to the initializing data structure of the video camera according to the embodiment. A part (a) of FIG. 4 is a schematic diagram for representing an entire structure of the initializing data stored in the flash ROM 3, and a part (b) of FIG. 4 is a schematic diagram for indicating such an initializing data which has been updated by rewriting the data specific to the optical disk. In this explanation, the initializing data of the flash ROM 3 is not compressed.

As indicated in the part (a) of FIG. 4, while the initializing data owns such a data amount (data length) equal to the entire area of the management information area 23, the management information data 27 corresponding to an effective data portion as the management information has been arranged, and data of “0” (namely, dummy data 28) have been arranged at such a portion which is not effective data as the management information. In this case, the management information data 27 own contents of information and insertion positions, which conforms to the UDF standard. The optical disk specific data 29 such as an initializing day/time, an initializing number, and CRC have been arranged in a portion of the information management data 27.

In such a case that in the step 38, the optical disk specific data such as latest initializing day/time, latest initializing number, and CRC owned by the microcomputer 9 are rewritten, the data portion of the optical disk specific data 29 is written as shown in the part (b) of FIG. 4.

Also, in such a case that the system used in the above-explained video camera corresponds to such a system that an information file specific to the own system must be formed on the optical disk 10, while such a data for this system specific information file is also stored in the flash ROM 3 subsequent to the initializing data, this information file data may be processed in combination with the initializing data from the step 37 to the step 42 in FIG. 3. In other words, the drive apparatus 6 is required to record the data as to the system specific information file from the head area of the user data area 24. When the recording operation of the initializing data is accomplished in the step 42, the recording operation of the initializing data is carried out just before the head area of this user data area 24, so that the drive apparatus 6 may continuously record the data as to the system specific information file without performing the seeking operation of the optical head. As a result, the time required to record the data as to the system specific information file can be reduced, and the waiting time for the user can be reduced, which may further improve the user operability.

It should also be understood that when such an optical disk as a DVD+RW disk in which an initializing format is only one sort is inserted into the video camera, process operations for this optical disk are carried out in accordance with the flow chart of FIG. 3 from which the step 36 is removed.

In the case that such an optical disk as a DVD-RAM disk is inserted in that two management information areas (namely, inner circumferential area and outer circumferential area) are required to be initialized in the initializing operations before being used, two sets of initializing data used for the inner circumferential area and the outer circumferential area are stored in the flash ROM 3. Then, in accordance with the flow chart of FIG. 3, after the initializing operation for the inner circumferential area has been ended, another initializing operation for the outer circumferential area is also carried out in accordance with the same flow chart. Although a seeking operation occurs from the lastmost area of the management information area of the inner circumferential area up to the head area of the management information area of the outer circumferential area, this seek time becomes the shortest seek time, so that the effect of this embodiment may be obtained.

It should also be noted that although the above-explained embodiment has exemplified the video camera, the present invention is not limited only to such a video camera, but may be applied to all of recording appliances which use such recording media that initializing operations of management information areas are required before these recording media are used.

It should be further understood by those skilled in the art that although the foregoing description has been made on embodiments of the invention, the invention is not limited thereto and various changes and modifications may be made without departing from the spirit of the invention and the scope of the appended claims.

1. A recording apparatus comprising:
recording means for recording data on a recording medium;
initializing means for initializing a management information area of said recording medium; and
storage means for storing thereinto initializing data which is recorded on the management information area of said recording medium when an initializing operation is carried out; wherein:
when the initializing operation is instructed, said initializing means records said initializing data which has been stored in said storage means on said management information area of said recording medium.

2. A recording apparatus as claimed in claim 1 wherein:
said initializing data owns a data structure in which dummy data and management information data are arrayed in a predetermined interval.

3. A recording apparatus as claimed in claim 1 wherein:
a data amount of said initializing data is substantially equal to a data amount of the management area of the recording medium.

4. A recording apparatus as claimed in claim 1, further comprising:
rewriting means for producing a portion of said management information data and for rewriting said produced data portion of said management information data; wherein:
when the initializing operation is instructed, second initializing data obtained by rewriting said produced data portion of the management information data by said rewriting means is recorded from a beginning area of the management information region of said recording medium.

5. A recording apparatus as claimed in claim 1 wherein:
said recording medium is an optical disk.

6. A recording apparatus as claimed in claim 1, further comprising:
imaging means for imaging a picture; wherein:
picture data imaged by said imaging means is recorded on said recording medium.

7. A recording apparatus as claimed in claim 1 wherein:
when said initializing operation is ended, said initializing means holds a head of said recording means at a place where a tail data portion of said initializing data has been recorded.

8. A recording apparatus as claimed in claim 2 wherein:
said initializing data contains “0” as said dummy data.

9. A recording apparatus comprising:
a drive for causing a head to seek a recording medium so as to record data on said recording medium;
a memory for holding therein initializing data which is employed so as to initialize said recording medium; and
a processing unit for performing both a physical formatting process operation and a recording operation of said initializing data within one seeking operation by said drive when the recording medium is initialized.

10. A recording apparatus as claimed in claim 9 wherein:
said one seeking operation corresponds to a seeking operation executed along only one direction within two directions along which the head is moved.

11. A recording apparatus as claimed in claim 9 wherein:
said initializing data owns a data structure in which dummy data and management information data are arrayed in a predetermined interval.

12. A recording apparatus as claimed in claim 9 wherein:
a data amount of said initializing data is substantially equal to a data amount of the management area of the recording medium.

13. A recording apparatus as claimed in claim 9, further comprising:
imaging means for imaging a picture.

14. A recording apparatus as claimed in claim 9 wherein:
when said physical formatting operation and the recording operation of said initializing data are accomplished, said processing unit holds said head at a place where a tail data portion of said initializing data has been recorded.

15. A recording apparatus as claimed in claim 9 wherein:
after said physical formatting operation and the recording operation of said initializing data are accomplished, said processing unit performs an error checking operation as to said physical formatting operation and/or the recording operation of said initializing data.
